(19) United States
(12) Patent Application Publication
(10) Pub. No.: US 2023/0091469 A1
(43) Pub. Date: Mar. 23, 2023

(54) ML ATTACK RESISTING METHOD FOR STRONG PUF

(71) Applicant: Wenzhou University, Zhejiang (CN)

(72) Inventors: Pengjun WANG, Zhejiang (CN); Ziyu Zhou, Zhejiang (CN); Gang LI, Zhejiang (CN); Xuejiao Ma, Zhejiang (CN); Huihong Zhang, Zhejiang (CN); Yijian SHI, Zhejiang (CN)

(73) Assignee: Wenzhou University, Zhejiang (CN)

(21) Appl. No.: 17/894,076

(22) Filed: Aug. 23, 2022

(30) Foreign Application Priority Data
Sep. 17, 2021 (CN) 202111091734.1

(51) Int. Cl. H04L 9/32; G06F 21/75; G06N 5/02

(52) U.S. Cl. CPC H04L 9/3278; G06F 21/75; G06N 5/022

(57) ABSTRACT

Disclosed is an ML attack resisting method for a strong PUF. Response signals generated by applying multiple sets of different challenge signals to a strong PUF are used as information to be encrypted, and are put in order to form a plaintext matrix. Then a matrix multiplication operation is performed on two plaintext matrixes to generate a ciphertext matrix. Next, elements in a transform matrix obtained by performing binary transformation on the ciphertext matrix are used as final responses, which are in one-to-one correspondence with original challenge signals and are used as final CRPs of the matrix-encrypted strong PUF.

### CROSS-REFERENCE TO RELATED APPLICATIONS

This application claims the priority benefit of China application serial no. 202111091734.1 filed on Sep. 17, 2022. The entirety of the above-mentioned patent application is hereby incorporated by reference herein and made a part of this specification.

### TECHNICAL FIELD

The invention relates to a machine learning (ML) attack resisting method, in particular to an ML attack resisting method for a strong physically unclonable function (PUF).

### BACKGROUND OF THE INVENTION

The physically unclonable function, as a new security application technology, can be applied to the fields of security key generation and low-cost authentication. The PUF can generate unpredictable security information in a non-storage manner by capturing differences in hardware fabrication, so as to lower the risk of information leakage. The input of the PUF is called challenge, the output of the PUF is called response, each challenge corresponds to a unique response, thus the corresponding challenge and response form a challenge response pair (CRP). PUFs are classified into weak PUFs and strong PUFs according to their different capacities to generate CRPs. The weak PUFs can only generate a limited number of CRPs, thus being mainly used for key generation or random number generation. The strong PUFs can generate a large number of CRPs by reconstructing hardware resources, thus being mainly used for device authentication.

However, the strong PUFs, especially arbiter PUFs (APUFs), are extremely likely to be attacked by ML such as logistic regression (LR), support vector machine (SVM) and artificial neural network (ANN). Due to the fact that the challenge of APUF is used for controlling the path of a signal passing through the PUF, the response reflects the sequence of signals reaching an arbiter along different paths, the total delay of the signal passing through each path is a cumulative delay of all levels of delays, there is a close linear relationship between the challenge for controlling each level of delay and the response representing the total delay, which makes the strong PUFs easy to model and prone to being attacked. The specific structure of the APUF is shown in FIG. 1. As for typical ML modeling attacks strong PUFs, challenge signals are mainly classified according to different values of response signals, a model is constructed according to the relationship between the challenge signals and the values of the response signals, and by training a certain number of CRPs, parameters in the model are optimized to fulfill an optimal dichotomy effect. After a classification function, namely a prediction model, is obtained, CRPs for testing are input into the prediction model to determine whether they are classified correctly, a final prediction rate is the ratio of the number of correctly predicted CRPs to the total number of tested CRPs, and the higher the prediction rate, the better the attack resistance. With the increase of the number of CRPs, the constructed model will be more accurate, and the prediction rate will be higher. As for a 64-bit APUF, when the number of collected CRPs reaches about 2000, the prediction accuracy of the model is over 95%.

To enhance the security of the PUF, Document 1 (Dan F, Xu Y, Li Z, et al. A Modeling Attack Resistant R-XOR APUF Based on FPGA[C] 2018 IEEE 3rd International Conference on Signal and Image Processing (ICSIP), 2018, pp. 577-581.) has proposed an R-XOR APUF which generates a final response by performing an XOR operation on responses of R APUFs, as shown in FIG. 2. Document 2 (Sahoo D P, Mukhopadhyay D, Chakraborty R S, et al. A Multiplexer-Based Arbiter PUF Composition with Enhanced Reliability and Security[J]. IEEE Transactions on Computers, 2018, 67(3):403-417.) puts forward a Multiplexer-Based MPUF, which uses responses of the APUF as data of a selection terminal and a selected terminal of a multiplexer, and uses an output of the multiplexer as a final response of the MPUF, as shown in FIG. 3. Although the strong PUFs proposed in these two documents can resist ML attacks to some extent, with the increase of the number of collected CRPs, the prediction rate of a model constructed based on a large number of CRPs is still high, so these strong PUFs are still quite likely to be attacked by ML.

### BRIEF SUMMARY OF THE INVENTION

The technical issue to be settled by the invention is to provide an ML attack resisting method for a strong PUF, which can greatly improve the ML attack resistance of the strong PUF, reduce the ML attack prediction rate to about 50% that is close to random guess, and make the strong PUF less likely to be attacked by ML.

The technical solution adopted by the invention to settle the above mentioned technical issue is as follows: an ML attack resisting method for a strong PUF comprises the following steps:

Step 1, collecting n² CRPs of a strong PUF, wherein n is any positive integer that is not less than 2; denoting a challenge signal of an x^{th} CRP of the strong PUF as Cₓ, wherein, x=1, 2, . . . , n², the challenge signal Cₓ is a b-bit binary number and is expressed as cₓ¹cₓ²cₓ³ . . . cₓ^{b}, cₓ^{a} represents a signal value of an a^{th} bit of the challenge signal of the x^{th} CRP, a=1, 2, . . . , b, the signal value cₓ^{a} represents a low level when its value is 0, and represents a high level when its value is 1; denoting a response signal of the x^{th} CRP of the strong PUF as Rₓ, wherein the response signal Rₓ is a 1-bit binary number, the response signal Rₓ represents a low level when its value is 0, and represents a high level when its value is 1, a one-to-one corresponding relationship exits in each CRP of the strong PUF, that is, the challenge signal Cₓ passes through the strong PUF to obtain the response signal Rₓ, and the corresponding relationship in the n² CRPs of the strong PUF is {C₁→R₁; C₂→R₂; . . . ; Cₙ_{^{2 →R}}ₙ_{²}};

Step 2, putting the response signals R₁, R₂, . . . , Rₙ_{²} of the collected n² CRPs of the strong PUF in order to form an n-order plaintext matrix, wherein the n-order plaintext matrix is denoted as M which is expressed by formula (1):

$$M = [ \begin{matrix}{m}_{11} & {m}_{12} & … & {m}_{1 n} \\ {m}_{21} & {m}_{22} & … & {m}_{2 n} \\ ⋮ & ⋮ & ⋱ & … \\ {m}_{n 1} & {m}_{n2} & … & {m}_{nn}\end{matrix} ] \qquad ( 1 )$$

Wherein, mᵢⱼ is an element in the i^{th} row and j^{th} column of the plaintext matrix M, i=1,2, . . . , n, j=1,2, . . . , n, m₁₁=R₁, m₁₂=R₂, . . . , mᵢⱼ=R_{(i-1)×n+j}, . . . , and mₙₙ=Rₙ_{²};

Step 3, multiplying the n-order plaintext matrix M by itself to obtain a ciphertext matrix, wherein the ciphertext matrix is denoted as S, which is expressed by formula (2):

$$S = M \cdot M = [ \begin{matrix}{m}_{11} & {m}_{12} & … & {m}_{1 n} \\ {m}_{21} & {m}_{22} & … & {m}_{2 n} \\ ⋮ & ⋮ & ⋱ & … \\ {m}_{n 1} & {m}_{n2} & … & {m}_{nn}\end{matrix} ] \cdot [ \begin{matrix}{m}_{11} & {m}_{12} & … & {m}_{1 n} \\ {m}_{21} & {m}_{22} & … & {m}_{2 n} \\ ⋮ & ⋮ & ⋱ & … \\ {m}_{n 1} & {m}_{n2} & … & {m}_{nn}\end{matrix} ] = [ \begin{matrix}{s}_{11} & {s}_{12} & … & {s}_{1 n} \\ {s}_{21} & {s}_{22} & … & {s}_{2 n} \\ ⋮ & ⋮ & ⋱ & … \\ {s}_{n 1} & {s}_{n2} & … & {s}_{nn}\end{matrix} ] \qquad ( 2 )$$

Wherein, sᵢⱼ is an element in the i^{th} row and j^{th} column of the ciphertext matrix S, i=1,2, . . . . , n, j=1,2, . . . , n, sⱼ=Σₖ₌₁ⁿmᵢₖmₖⱼ, and k=1,2, . . . , n;

Step 4, performing binary transform on the ciphertext matrix S to obtain a transform matrix S′, and denoting an element in the i^{th} row and j^{th} column of transform matrix as s′ᵢⱼ, specifically: determining whether the element sᵢⱼ is an odd number or an even number; if the element sᵢⱼ is an odd number, the element s′ᵢⱼ=1; or, if the element sᵢⱼ is an even number, the element s′ᵢⱼ=0;

Step 5, sequentially using elements in the transform matrix S′ as final response signals r₁˜rₙ_{²} of the strong PUF, wherein r₁=s′₁₁, r₂=s′₁₂, . . . , r_{(i-1)×n+j}=s′ᵢⱼ, rₙ_{²}=s′ₙₙ, at this moment, a one-to-one corresponding relationship still exists in each CRP of the strong PUF, the challenge signal Cₓ passes through the strong PUF to obtain a final response signal rₓ, the challenge signal Cₓ corresponds to the final response signal rₓ, and a final corresponding relationship of the n² CRPs of the strong PUF is {C₁→r₁; C₂→r₂; . . . ; Cₙ_{²}→rₙ_{²}}; and

Step 6, repeating Step 2 to Step 5 until the number of CRPs reaches a preset required value.

Compared with the prior art, the invention has the following advantages: response signals generated by applying multiple sets of different challenge signals to a strong PUF are used as information to be encrypted, and are put in order to form a plaintext matrix. Then, an encryption operation is performed by multiplying two plaintext matrixes to generate a ciphertext matrix. Next, elements in a transform matrix obtained by performing binary transformation on the ciphertext matrix are used as final responses, which are in one-to-one correspondence with original challenge signals, and are used as final CRPs of the matrix-encrypted strong PUF. In the invention, the correlation between the challenge signals and the response signals is greatly reduced by matrix encryption. The final response signals are not only correlated with the corresponding challenge signals, but also correlated with challenge signals corresponding to other response signals participating in matrix encryption. The correlation between challenges and responses is further reduced, so the attack prediction rate may be decreased to about 50%, which is close to random guesses, and the attack resistance is improved by four to five magnitudes. Moreover, due to the unidirectionality of matrix self-multiplication encryption, even if an attacker steals encrypted response signal data, the attacker cannot obtain the initial response signals through a decryption algorithm, so a complete anti-attack property is realized. Therefore, the invention can greatly improve the ML attack resistance of the strong PUF, reduce the ML attack prediction rate to about 50% that is close to random guesses, and make the strong PUF less likely to be attacked by ML.

### BRIEF DESCRIPTION OF THE SEVERAL VIEWS OF THE DRAWINGS

FIG. 1 is a structural diagram of a traditional APUF.

FIG. 2 is a structural diagram of an existing R-XOR APUF.

FIG. 3 is a structural diagram of an existing MPUF.

FIG. 4 is a flow diagram of encrypting a strong PUF through an ML attack resisting method for a strong PUF according to the invention.

FIG. 5 illustrates the relationship between the attack prediction rate and the number of training sets CRP under the condition that of a 64-bit APUF adopts the ML attack resisting method for a strong PUF and the relationship between the attack prediction rate and the number of training sets CRP under the condition that the 64-bit APUF does not adopt the ML attack resisting method for a strong PUF according to the invention.

FIG. 6 illustrates the relationship between the order n of a plaintext matrix of the ML attack resisting method for a strong PUF and the attack prediction rate according to the invention.

FIG. 7 illustrates the relationship between the proportion of 0/1 in responses of 100,000 CRPs and the order n of a plaintext matrix under the condition that the 64-bit APUF adopts the ML attack resisting method for a strong PUF according to the invention.

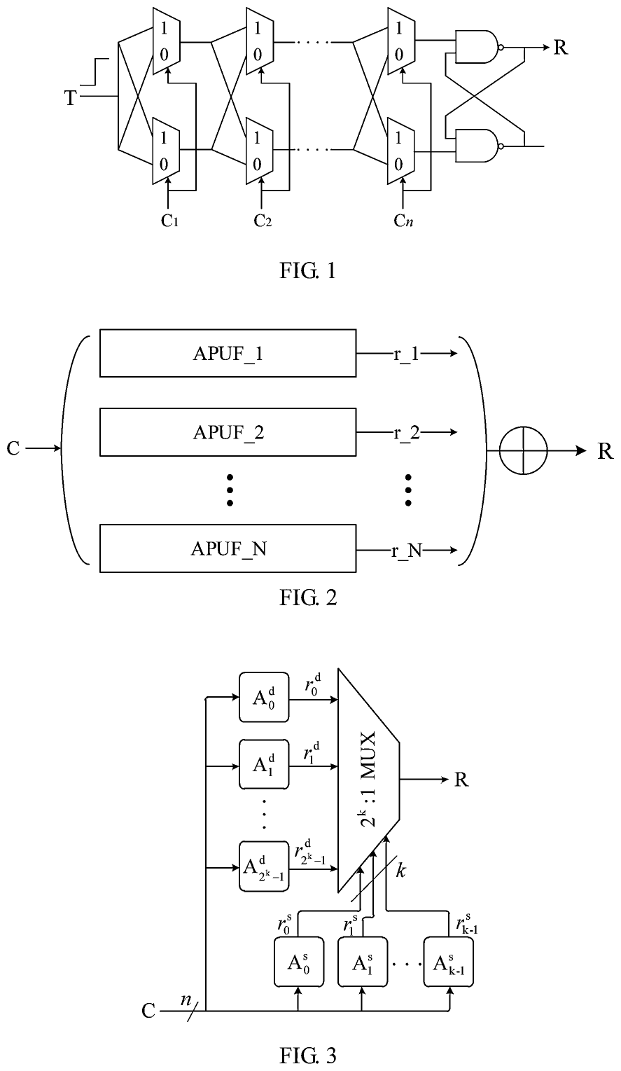

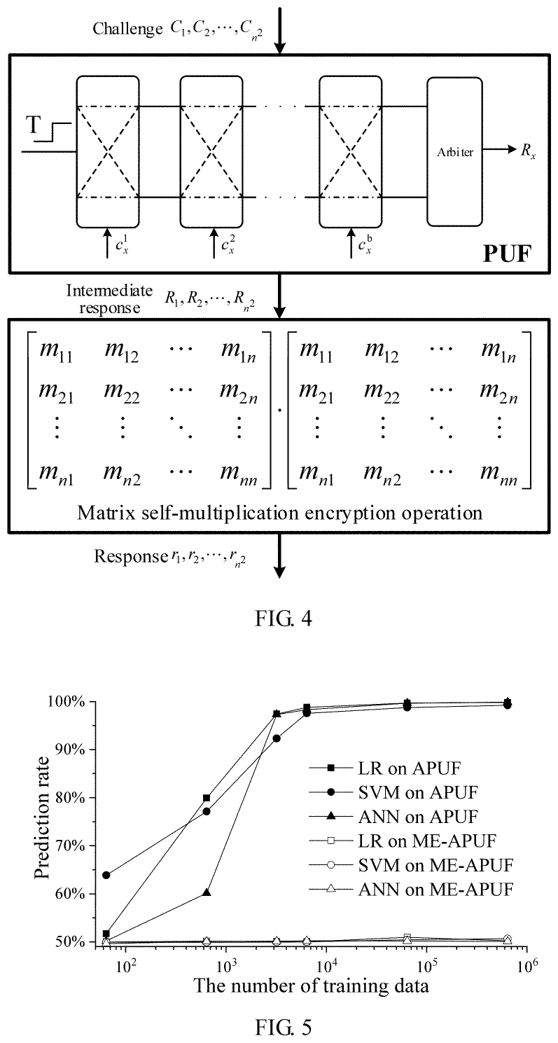

### DETAILED DESCRIPTION OF THE INVENTION

The invention will be described in further detail below in conjunction with the accompanying drawings and embodiments.

Embodiment: an ML attack resisting method for a strong PUF comprises the following steps:

Step 1, n² CRPs of a strong PUF are collected, wherein n is any positive integer that is not less than 2; a challenge signal of an x^{th} CRP of the strong PUF is denoted as Cₓ, wherein, x=1, 2, . . . , n², the challenge signal Cₓ is a b-bit binary number and is expressed as cₓ¹cₓ²cₓ³ . . . cₓ^{b}, cₓ^{a} represents a signal value of an a^{th} bit of the challenge signal of the x^{th} CRP, a=1, 2, . . . , b, the signal value cₓ^{a} represents a low level when its value is 0, and represents a high level when its value is 1; a response signal of the x^{th} CRP of the strong PUF is denoted as Rₓ, wherein the response signal Rₓ is a 1-bit binary number, the response signal Rₓ represents a low level when its value is 0, and represents a high level when its value is 1, a one-to-one corresponding relationship exits in each CRP of the strong PUF, that is, the challenge signal Cₓ passes through the strong PUF to obtain the response signal Rₓ, and the corresponding relationship in the n² CRPs of the strong PUF is {C₁→R₁; C₂→R₂; . . . ; Cₙ_{^{2 →R}}ₙ_{²}};

Step 2, the response signals R₁, R₂, . . . , Rₙ_{²} of the collected n² CRPs of the strong PUF are put in order to form an n-order plaintext matrix, wherein the n-order plaintext matrix is denoted as M which is expressed by formula (1):

$$M = [ \begin{matrix}{m}_{11} & {m}_{12} & … & {m}_{1 n} \\ {m}_{21} & {m}_{22} & … & {m}_{2 n} \\ ⋮ & ⋮ & ⋱ & … \\ {m}_{n 1} & {m}_{n2} & … & {m}_{nn}\end{matrix} ] \qquad ( 1 )$$

Wherein, mᵢⱼ is an element in the i^{th} row and j^{th} column of the plaintext matrix M, i =1,2, . . . , n, j=1,2, . . . , n, m₁₁=R₁, m₁₂=R₂, . . . , mᵢⱼ=R_{(i-1)×n+j}, . . . , and mₙₙ=Rₙ_{²};

Step 3, the n-order plaintext matrix M is multiplied by itself to obtain a ciphertext matrix, wherein the ciphertext matrix is denoted as S, which is expressed by formula (2):

$$S = M \cdot M = [ \begin{matrix}{m}_{11} & {m}_{12} & … & {m}_{1 n} \\ {m}_{21} & {m}_{22} & … & {m}_{2 n} \\ ⋮ & ⋮ & ⋱ & … \\ {m}_{n 1} & {m}_{n2} & … & {m}_{nn}\end{matrix} ] \cdot [ \begin{matrix}{m}_{11} & {m}_{12} & … & {m}_{1 n} \\ {m}_{21} & {m}_{22} & … & {m}_{2 n} \\ ⋮ & ⋮ & ⋱ & … \\ {m}_{n 1} & {m}_{n2} & … & {m}_{nn}\end{matrix} ] = [ \begin{matrix}{s}_{11} & {s}_{12} & … & {s}_{1 n} \\ {s}_{21} & {s}_{22} & … & {s}_{2 n} \\ ⋮ & ⋮ & ⋱ & … \\ {s}_{n 1} & {s}_{n2} & … & {s}_{nn}\end{matrix} ] \qquad ( 2 )$$

Wherein, sᵢⱼ is an element in the i^{th} row and j^{th} column of the ciphertext matrix S, i=1,2, . . . , n, j=1,2, . . . , n, sᵢⱼ=Σₖ₌₁ⁿmᵢₖmₖⱼ, and k=1,2, . . . , n;

Step 4, binary transform is performed on the ciphertext matrix S to obtain a transform matrix S′, and an element in the i^{th} row and j^{th} column of transform matrix is denoted as s′ᵢⱼ, specifically: whether the element sᵢⱼ is an odd number or an even number is determined; if the element sᵢⱼ is an odd number, the element s′ᵢⱼ=1 ; or, if the element sᵢⱼ is an even number, the element s′ᵢⱼ=0;

Step 5, elements in the transform matrix S′ are sequentially used as final response signals r₁˜rₙ_{²} of the strong PUF, wherein r₁=s′₁₁, r₂=s′₁₂, . . . , r_{(i-1)×n+j}=s′ᵢⱼ, rₙ_{²}=s′ₙₙ, at this moment, a one-to-one corresponding relationship still exists in each CRP of the strong PUF, the challenge signal Cₓ passes through the strong PUF to obtain a final response signal rₓ, the challenge signal Cₓ corresponds to the final response signal rₓ, and a final corresponding relationship of the n² CRPs of the strong PUF is {C₁→r₁; C₂→r₂; . . . ; Cₙ_{²}→rₙ_{²}}; and

Step 6, Step 2 to Step 5 are repeated until the number of CRPs reaches a preset required value.

When a certain number of CRPs are collected, the performance of the ML attack resisting method for a strong PUF in the invention is verified through python simulation, and the distribution of 0/1 in responses obtained by adopting the ML attack resisting method in the invention is tested to determine the randomness of the ML attack resisting method.

The relationship between the attack prediction rate and the number of training sets CRP under the condition that a 64-bit APUF adopts the ML attack resisting method of the invention and the relationship between the attack prediction rate and the number of training sets CRP under the condition that the 64-bit APUF does not adopt the ML attack resisting method of the invention adopted are shown in FIG. 5. Wherein, the horizontal axis represents the number of the training sets, and the vertical axis represents the attack prediction rate. LR on APUF represents the prediction rate of modeling attacks performed on the 64-bit APUF with LR, the prediction rate increases continuously with the increase of the number of training sets, and when the number of training sets reaches 10,000, the prediction rate is basically stabilized at 99.9%. SVM on APUF represents the prediction rate of modeling attacks performed on the 64-bit APUF with SVM, the prediction rate increases continuously with the increase of the number of training sets, and when the number of training sets reaches 10,000, the prediction rate is basically stabilized at 99.9%. ANN on APUF represents the prediction rate of modeling attacks performed on the 64-bit APUF with ANN, the prediction rate increases continuously with the increase of the number of training sets, and when the number of training sets reaches 10,000, the prediction rate is basically stabilized at 99.9%. LR on ME-APUF represents the prediction rate of modeling attacks performed with LR on the 64-bit APUF adopting the ML attack resisting method in the invention, and the prediction rate is always maintained at about 50% with the increase of the number of training sets. SVM on ME-APUF represents the prediction rate of modeling attacks performed with SVM on the 64-bit APUF adopting the ML attack resisting method in the invention, and the prediction rate is always maintained at about 50% when the increase of the number of training sets. ANN on ME-APUF represents the prediction rate of modeling attacks performed with ANN on the 64-bit APUF adopting the ML attack resisting method in the invention, and the prediction rate is always maintained at about 50% when the increase of the number of training sets. By analyzing FIG. 5, it is known that under the condition that the ML attack resisting method for a strong PUF in the invention is not adopted, the prediction rate of the several types of ML attacks is close to 90% when 2000 CRPs of the APUF are collected, and with the increase of the number of CRPs, the prediction rate will increase continuously and will be close to 99.9%. Under the condition that the ML attack resisting method for a strong PUF in the invention is adopted, the prediction rate is always maintained at about 50.01% even if a large number of collected CRPs are attacked. So, it can be concluded that the ML attack resisting method for a strong PUF in the invention has a good capacity to resist ML attacks, and comparing to the original PUFs, the attack resistance is improved by multiple magnitudes.

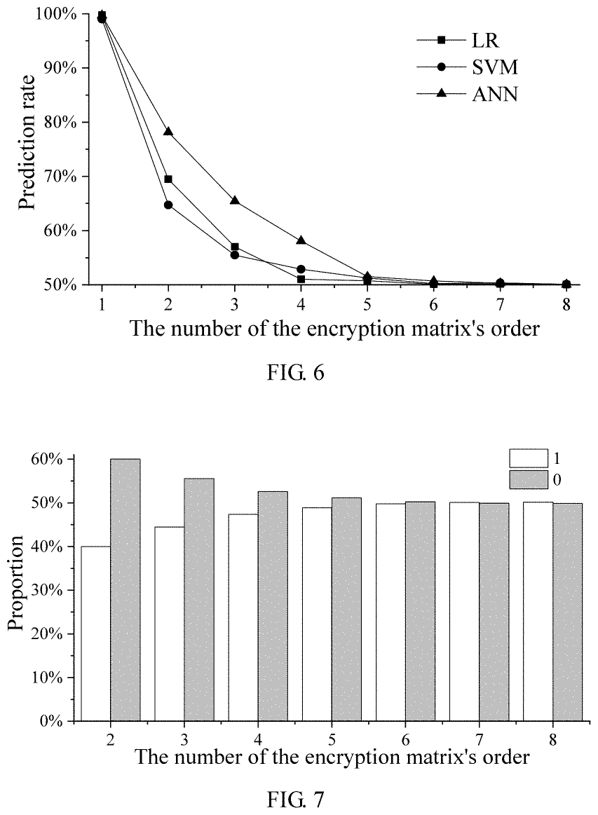

The relationship between the order n of the plaintext matrix in the ML attack resisting method for a strong PUF of the invention and the attack prediction rate is shown in FIG. 6. In FIG. 6, the horizontal axis represents the order n of the plaintext matrix in the ML attack resisting method for a strong PUF of the invention, and the vertical axis represents the attack prediction rate. The curve LR represents the prediction rate of modeling attacks performed on the 64-bit APUF with LR, and the prediction rate decreases gradually with the gradual increase of the order n of the plaintext matrix in the ML attack resisting method for a strong PUF of the invention, and is basically stabilized at about 50% when the order of the plaintext matrix is over 5. Curve SVM represents the prediction rate of modeling attacks performed on the 64-bit APUF with SVM, and the prediction rate decreases gradually with the gradual increase of the order n of the plaintext matrix in the ML attack resisting method for a strong PUF of the invention, and is basically stabilized at about 50% when the order of the plaintext matrix is over 5. Curve ANN represents the prediction rate of modeling attacks performed on the 64-bit APUF with ANN, and the prediction rate decreases gradually with the gradual increase of the order n of the plaintext matrix in the ML attack resisting method for a strong PUF of the invention, and is basically stabilized at about 50% when the order of the plaintext matrix is over 5. By analyzing FIG. 6, it is know that the attack prediction rate decreases with the increase of the order n of the plaintext matrix in the ML attack resisting method for a strong PUF of the invention, and is finally maintained at about 50.1%. When the order of the plaintext matrix is over 5, the attack resisting effect of the ML attack resisting method for a strong PUF of the invention becomes stable. So, in actual application, in order to guarantee the attack resistance of the ML attack resisting method, the order n of the plaintext matrix in the ML attack resisting method for a strong PUF of the invention should be not less than 5.

The relationship between the proportion of 0/1 in responses of 100,000 CRPs and the order n of the plaintext matrix under the condition that the 64-bit APUF adopts the ML attack resisting method for a strong PUF of the invention is shown in FIG. 7. In FIG. 7, the horizontal axis represents the order n of the plaintext matrix in the matrix encryption algorithm and the vertical axis represents the proportion of 0/1 in all responses. By analyzing FIG. 7, it is known that the proportion of 0/1 in all the responses will be balanced with the increase of the order n of the plaintext matrix in the ML attack resisting method for a strong PUF of the invention, and is close to 50% when the order n of the plaintext matrix in the ML attack resisting method for a strong PUF of the invention is over 5. So, in order to guarantee good randomness of responses generated by the ML attack resisting method for a strong PUF of the invention, the order n of the plaintext matrix in the ML attack resisting method for should not be less than 5.

To sum up, the ML attack resisting method for a strong PUF provided by the invention can greatly improve the ML resistance of the strong PUF. Comparing with an original strong PUF not using the method, the correlation between challenge signals and response signals is greatly reduced through encryption of the ML attack resisting method for a strong PUF. The final response signals are not only correlated with the corresponding challenge signals but also correlated with challenge signals corresponding to other response signals participating in matrix encryption, thus the correlation between challenges and responses is further reduced. The final attack prediction rate may be decreased to about 50%, which is close to random guesses, and the attack resistance is improved by four to five magnitudes. In addition, due to the unidirectionality of matrix self-multiplication encryption, even if an attacker steals encrypted response signal data, the attacker cannot obtain the initial response signals through a decryption algorithm, so this method has a good anti-attack capacity and may be used by public. Moreover, in order to guarantee the maximum attack resistance of the algorithm and the optimal randomness of the responses, the order n of the plaintext matrix in the matrix encryption algorithm should not be less than 5.

What is claimed is:

1. An machine learning (ML) attack resisting method for a strong physically unclonable function (PUF), characterized in that, the method comprises the following steps:
Step 1, collecting n² challenge response pairs (CRP) of the strong PUF, wherein the n is a positive integer that is not less than 2; denoting a challenge signal of an x^{th} CRP of the strong PUF as Cₓ, wherein, x=1, 2, . . . , n², the challenge signal Cₓ is a b-bit binary number and is expressed as cₓ¹cₓ²cₓ³ . . . cₓ^{b}, cₓ^{a} represents a signal value of an a^{th} bit of the challenge signal Cₓ of the x^{th} CRP, a=1, 2, . . . , b, the signal value cₓ^{a} represents a low level when its value is 0, and represents a high level when its value is 1; denoting a response signal of the x^{th} CRP of the strong PUF as Rₓ, wherein the response signal Rₓ is a 1-bit binary number, the response signal Rₓ represents a low level when its value is 0, and represents a high level when its value is 1, a one-to-one corresponding relationship exits in each CRP of the strong PUF, the challenge signal Cₓ passes through the strong PUF to obtain the response signal Rₓ, and the corresponding relationship in the n² CRPs of the strong PUF is {C₁→R₁; C₂→R₂; . . . ; Cₙ_{^{2 →R}}ₙ_{²}};
Step 2, putting the response signals R₁, R₂, . . . , Rₙ_{²} of the collected n² CRPs of the strong PUF in order to form an n-order plaintext matrix, wherein the n-order plaintext matrix is denoted as M, which is expressed by formula (1):
$$M = [ \begin{matrix}{m}_{11} & {m}_{12} & … & {m}_{1 n} \\ {m}_{21} & {m}_{22} & … & {m}_{2 n} \\ ⋮ & ⋮ & ⋱ & … \\ {m}_{n 1} & {m}_{n2} & … & {m}_{nn}\end{matrix} ] \qquad ( 1 )$$
wherein, mᵢⱼ is an element in i^{th} row and j^{th} column of the plaintext matrix M, i=1,2, . . . , n, j=1,2, . . . , n, m₁₁=R₁, m₁₂=R₂, . . . , mᵢⱼ=R_{(i-1)×n+j}, . . . , and mₙₙ=Rₙ_{²};
Step 3, multiplying the n-order plaintext matrix M by itself to obtain a ciphertext matrix, wherein the ciphertext matrix is denoted as S, which is expressed by formula (2):
$$S = M \cdot M = [ \begin{matrix}{m}_{11} & {m}_{12} & … & {m}_{1 n} \\ {m}_{21} & {m}_{22} & … & {m}_{2 n} \\ ⋮ & ⋮ & ⋱ & … \\ {m}_{n 1} & {m}_{n2} & … & {m}_{nn}\end{matrix} ] \cdot [ \begin{matrix}{m}_{11} & {m}_{12} & … & {m}_{1 n} \\ {m}_{21} & {m}_{22} & … & {m}_{2 n} \\ ⋮ & ⋮ & ⋱ & … \\ {m}_{n 1} & {m}_{n2} & … & {m}_{nn}\end{matrix} ] = [ \begin{matrix}{s}_{11} & {s}_{12} & … & {s}_{1 n} \\ {s}_{21} & {s}_{22} & … & {s}_{2 n} \\ ⋮ & ⋮ & ⋱ & … \\ {s}_{n 1} & {s}_{n2} & … & {s}_{nn}\end{matrix} ] \qquad ( 2 )$$
wherein, sᵢⱼ is an element in i^{th} row and j^{th} column of the ciphertext matrix S, i=1,2, . . . , n, j=1,2, . . . , n, sᵢⱼ=Σₖ₌₁ⁿmᵢₖmₖⱼ, and k=1,2, . . . , n;
Step 4, performing a binary transformation on the ciphertext matrix S to obtain a transform matrix S′, and denoting an element in i^{th} row and j^{th} column of the transform matrix S′ as s′ᵢⱼ, the binary transformation comprises: determining whether the element sᵢⱼ is an odd number or an even number; if the element sᵢⱼ is an odd number, the element s′ᵢⱼ=1; or, if the element sᵢⱼ is an even number, the element s′ᵢⱼ=0;
Step 5, sequentially using elements in the transform matrix S′ as final response signals r₁˜rₙ_{²} of the strong PUF, wherein r₁=s′₁₁, r₂=s′₁₂, . . . , r_{(i-1)×n+j}=s′ᵢⱼ, rₙ_{²}=s′ₙₙ, at this moment, a one-to-one corresponding relationship still exists in each CRP of the strong PUF, the challenge signal Cₓ passes through the strong PUF to obtain a final response signals rₓ, the challenge signal Cₓ corresponds to the final response signals rₓ, and a final corresponding relationship of the n² CRPs of the strong PUF is {C₁→r₁; C₂→r₂; . . . ; Cₙ_{²}→rₙ_{²}}; and
Step 6, repeating Step 2 to Step 5 until the number of CRPs reaches a preset required value.
